(19) United States
(12) Patent Application Publication
(10) Pub. No.: US 2008/0172231 A1
(43) Pub. Date: Jul. 17, 2008

(54) Method of Processing Sound Signals for a Communication Terminal and Communication Terminal Using that Method

(75) Inventors: Arnaud Parisel, La Murette (FR); Frederic Lejay, Paris (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL LUCENT, PARIS (FR)

(21) Appl. No.: 11/570,755

(22) PCT Filed: Jun. 16, 2005
(86) PCT No.: PCT/FR2005/050450

§ 371 Date: Feb. 1, 2008

(30) Foreign Application Priority Data
Jun. 16, 2004 (FR) 0451186

(51) Int. Cl. G10L 15/00

(52) U.S. Cl. 704/251; 704/E15.001

(57) ABSTRACT

The present invention relates to a method of processing voice signals (320, 322, 324) for a communication terminal (300) using voice recognition means comparing those voice signals to data stored in a database (304) in order to identify the data corresponding to those signals, that identified data being transmitted to management means (312) for triggering an action. According to the invention, such a method is characterized in that, the voice signals being liable to be supplied different sound acquisition systems (305, 307, 309), separate voice recognition means are used for each acquisition system.

The present invention relates to a method of processing sound signals for a communication terminal and to a communication terminal using that method, in particular for using that communication terminal with different sound acquisition systems.

This invention may be used in particular in mobile telephony.

There are known communication terminals using functions necessitating voice recognition, for example to initiate a call by speaking the name of the called party or for starting certain functions such as the display of a calendar.

In a communication terminal the voice recognition means, particularly the means for processing and storing information, are limited because of restrictions on weight, cost and overall size that the designers of these communication terminals must comply with, particularly in the case of mobile communication terminals.

Moreover, the same communication terminal, and therefore the same set of voice recognition means, may be used with different sound acquisition systems, including in particular different microphones and/or different means of connection to the communication terminal, as described in detail hereinafter.

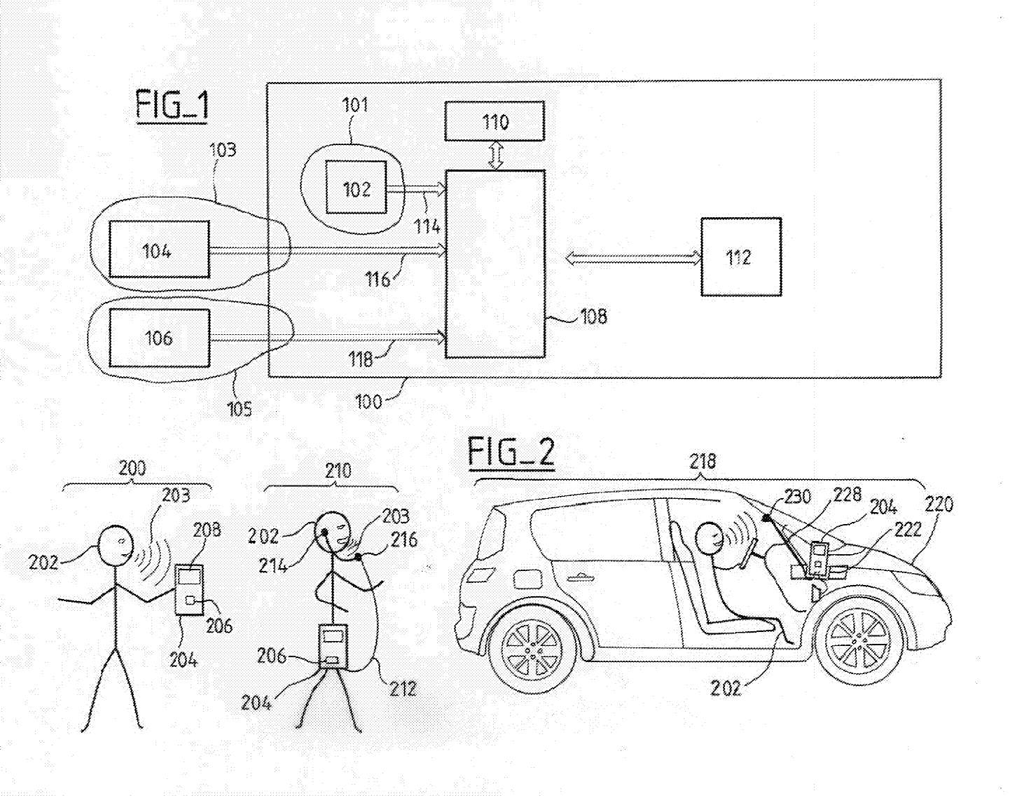

FIG. 1 represents diagrammatically the operation of voice recognition in one example of the prior art.

A communication terminal 100, including internal voice recognition means 108, uses different sound acquisition systems alternately: a system 101 including in particular an internal microphone 102, a system 103 of a pedestrian hands-free kit including in particular a microphone 104 external to the communication terminal 100, or a system 105 of a car hands-free kit including in particular a microphone 106 external to the communication terminal 100.

These recognition means compare parameters extracted from a signal 114, 116 or 118 respectively transmitted by one of the systems 101, 103 or 105, with parameters contained in a database 110 internal to the communication terminal and each representing an item of data, for example a name or a function.

To this end, this operation generally employs a recognition score for each comparison and chooses the stored set of parameters having the best recognition score exceeding a particular validation threshold.

If a set of stored parameters is sufficiently close to the parameters extracted from the received signal, then that set is transmitted to management means 112 of the communication terminal to perform an operation such as making a call.

This closeness is also called the voice recognition rate of a communication terminal. It is accepted that this success rate must exceed 95% for the voice recognition method to be valid.

The database 110 is constructed in particular by storing in the factory so-called multispeaker sequences because, for the same sequence, they incorporate potential sound differences between different persons.

It may also be constructed by a so-called learning procedure which involves the specific user associating a sound with an item of data or a function of the communication terminal 100 by means of functions specific to the communication terminal.

According to an observation specific to the invention, it is apparent that the user can use the communication terminal 100 with different sound acquisition systems 101, 103 or 105 such that each of those systems introduces its own distortion into the signal emitted by the user 102 (in particular harmonic distortion thereof, specific distortion of the volume thereof or of its sensitivity to background noise and echoes).

Because of this, the voice recognition rate of a communication terminal is often judged insufficient for the user to use the voice recognition facility of his communication terminal if that communication terminal is used with a sound signal acquisition system other than that with which the learning procedure was conducted or on the basis of which the multispeaker prerecordings were effected.

This is why the invention relates to a method of processing voice signals for a communication terminal using voice recognition means comparing those voice signals to data stored in a database in order to identify the data corresponding to those signals, that identified data being transmitted to management means for triggering an action, characterized in that, the voice signals being liable to be supplied different sound acquisition systems, separate voice recognition means are used for each acquisition system.

Thanks to this invention, the voice recognition rate is made satisfactory for different sound acquisition systems of the communication terminal because the processing of the signals is adapted to each acquisition system.

A user can therefore use the voice recognition function satisfactorily with all sound acquisition systems that may be used in relation to his communication terminal.

In one embodiment, the database comprises independent sub-bases, each sub-base being associated with one sound acquisition system so that the voice recognition means give priority to using the sub-base associated with the sound acquisition system used to effect the comparison.

In one embodiment, the comparison between a signal and the stored data is done successively for each of the sub-bases until a required recognition rate is achieved by that comparison.

In one embodiment, a voice recognition learning procedure is done with different voice recognition systems to generate the sub-bases specific to each voice recognition system.

In one embodiment, the voice recognition means of the communication terminal incorporate at least two sound signal filters, each of the filters being specific to one sound acquisition system of the communication terminal.

In one embodiment, the filters have predetermined filter characteristics.

In one embodiment, the signals delivered by the filters are processed identically by the voice recognition means vis à vis the database.

In one embodiment, the voice recognition means contain fixed filter means associated with a first voice recognition system and dynamic filter means associated with a second filter system, these dynamic filter means detecting the characteristics of the fixed filtering to deliver a signal analogous to the signal delivered by the fixed filtering.

The invention also relates to a communication terminal processing voice signals using voice recognition means comparing those voice signals to data stored in a database in order to identify the data corresponding to those signals, that identified data being transmitted to management means for triggering an action, characterized in that, the voice signals being liable to be supplied different sound acquisition systems, it comprises separate voice recognition means for each acquisition system.

In one embodiment, the communication terminal is characterized in that the database is situated externally of the communication terminal in a server.

In one embodiment, the communication terminal includes, in the database, independent sub-bases, each sub-base being associated with one sound acquisition system so that the voice recognition means give priority to using the sub-base associated with the sound acquisition system used by the user to effect the comparison.

In one embodiment, the communication terminal comprises means for done the comparison between a signal and the stored data successively for each of the sub-bases until a required recognition rate is achieved by that comparison.

In one embodiment, the communication terminal comprises means for done a voice recognition learning procedure with different voice recognition systems to generate the sub-bases specific to each voice recognition system.

In one embodiment, the communication terminal comprises in the voice recognition means at least two sound signal filters, each of the filters being specific to one sound acquisition system of the communication terminal.

In one embodiment, the communication terminal comprises filters that have predetermined fixed filter characteristics.

In one embodiment, the communication terminal comprises means whereby the filtered signals are processed identically by the voice recognition means vis à vis the database.

In one embodiment, the communication terminal comprises voice recognition means that contain fixed filter means associated with a first voice recognition system and dynamic filter means associated with a second filter system, these dynamic filter means detecting the characteristics of the fixed filtering to deliver a signal analogous to the signal delivered by the fixed filtering.

In one embodiment, the communication terminal comprises a microphone.

In one embodiment, one of the sound acquisition systems is a pedestrian hands-free kit, a hands-free kit for a vehicle or a recognition system integrated into the communication terminal.

Other features and advantages of the invention will become apparent in the light of the description given hereinafter, by way of nonlimiting example, with reference to the appended figures, in which:

FIG. 1, already described, represents one example of prior art voice recognition for communication terminals,

FIG. 2 is a diagrammatic representation of applications using the invention,

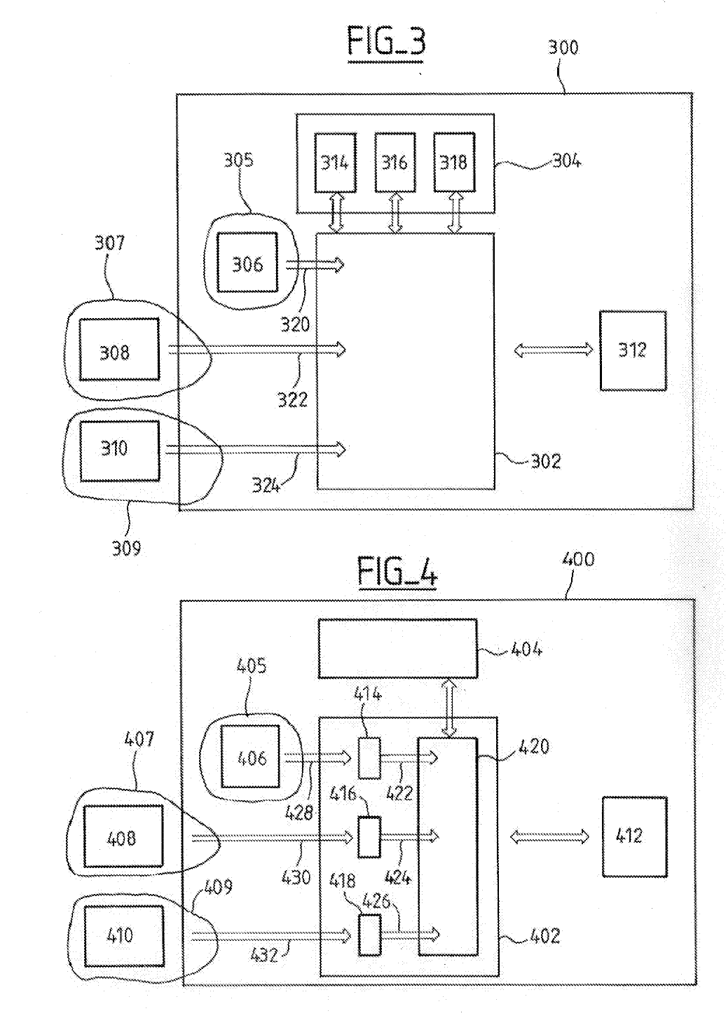

FIG. 3 is a diagram of a first embodiment of the invention,

FIG. 4 is a diagram of a second embodiment of the invention,

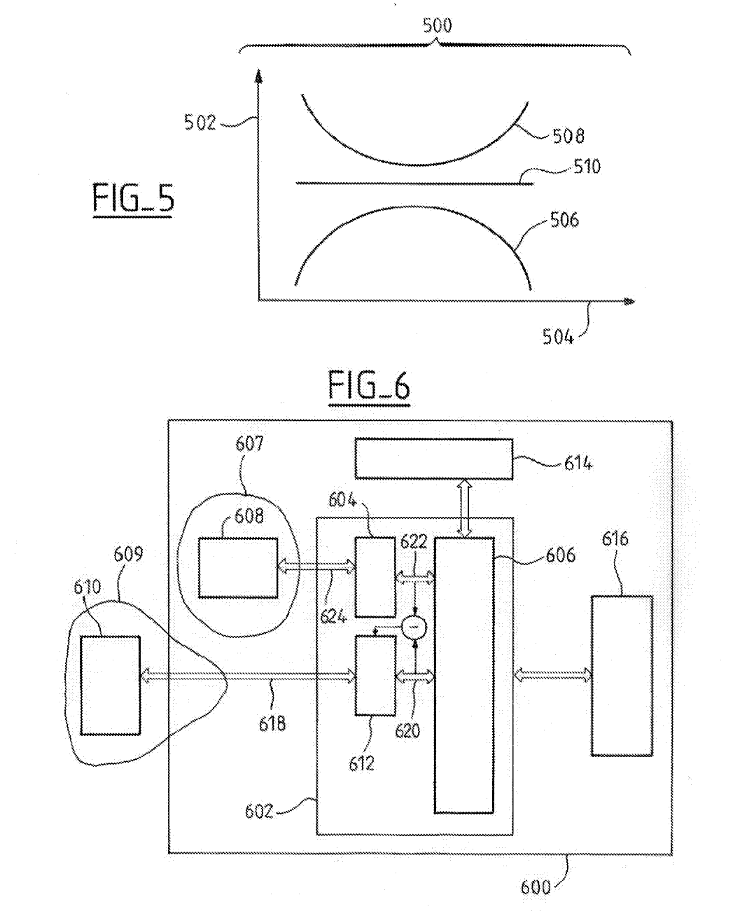

FIG. 5 is a diagram showing a spectral correction introduced into different embodiments of the invention, and

FIG. 6 is a diagrammatic representation of a third embodiment of the invention.

FIG. 2 represents diagrammatically the use of the voice recognition method according to the invention for three sound acquisition systems of the same mobile communication terminal 204 used by a user 202.

In this case, it is considered that the so-called voice recognition learning step has been carried out, the user being able to trigger a function of the communication terminal by means of his voice or any other recognizable sound signal.

For example, the user 202, by means of his voice 203, commands his communication terminal 204 to make a call to a contact simply by speaking the forename of that contact.

The situation of use 200 of the voice recognition function of the mobile communication terminal 204 is used, for example, with a sound acquisition system 206 integrated into the communication terminal 204 and including a microphone.

As already described, the voice recognition means of the communication terminal compare the parameters of his signal then transmitted by the system 206 with the sets of parameters stored in the database.

If the comparison is a success, then the communication terminal 204 initiates the call to the required contact.

The user 202 may then decide to clip his communication terminal 204 to his belt or to put it in his pocket, in a situation of use 210 of the mobile communication terminal 204 with a sound acquisition system 212, usually called a pedestrian hands-free kit, integrating in particular a microphone 216, near the mouth of the user 202, and an earpiece 214 and the cables and connecting means connecting them to the communication terminal 204.

Thanks to the invention, the user can speak the name of his contact into the microphone 216 and successfully command a call to that contact.

The user 202 may then decide to use his communication terminal 204 with the aid of another sound acquisition system 228 in a car 220, in a situation of use 218 of the mobile communication terminal 204 with a car hands-free kit, integrating in particular a microphone 230 and the cables and connecting means 222 connecting them to the communication terminal 204.

The user speaks the name of his contact into the microphone 230 and thereby commands a call to that contact.

It is therefore apparent that a user 202 can use the voice recognition function of his communication terminal 204 with various sound acquisition systems 206, 212 or 228, which does not cause any voice recognition problem if a method according to the invention is used, three preferred embodiments of the invention being described hereinafter:

A first embodiment is represented diagrammatically in FIG. 3, including a communication terminal 300 equipped in particular with voice recognition means 302, a database 304 of sets of parameters, each of said sets corresponding to a function to be recognized, an internal sound acquisition system 305 including in particular an integrated microphone 306 and management means 312 of the communication terminal 300.

The communication terminal may also use a sound acquisition system 307, corresponding to the pedestrian hands-free kit, for example, including a microphone 308 and a sound acquisition system 309 corresponding to the car hands-free kit, for example, comprising in particular a microphone 310.

The user then performs the voice recognition learning procedure with the various systems 305, 307 and 309 integrating the various microphones 306, 308 and 310.

Furthermore, the communication terminal comprises means for detecting the sound acquisition system used and inhibiting the other systems.

Accordingly, in a first operation, a user performs the learning process using the integrated microphone 306 of his communication terminal 300, for example by selecting on his communication terminal the function that he wishes to associate with a sequence of sounds and then making that sequence of sounds one or several times.

This generates a signal 320 depending on the characteristics of the system 305. The voice recognition means 302 extract a set of parameters from this signal 320 which is then stored in a sub-base or partition 314 of the database 304.

Then, in a second operation, the user installs the system 307 including another microphone 308, of the hands-free kit, and also performs the learning process with the microphone 308 for the function previously processed. The voice recognition means 302 extract a set of parameters from the signal 322, depending on the system 307, which set is stored in a partition 316 of the database 304.

Finally, in a third operation, the user installs the system 309 including another microphone 310 of the car hands-free kit, and performs the learning process one time more for the same data item or the same function as before. The voice recognition means 302 extract a set of parameters from the signal 324 then transmitted by the system 309, which set is then stored in a partition 318 of the database 304.

Other sound acquisition systems may be associated in a similar way if the user is going to start them up. In this case, the sets of parameters obtained by the learning procedure are stored in a new partition associated with each of the other microphones.

To conclude, different sets of parameters (one for each sound acquisition system used) are associated with the same function: they are stored in partitions of the database 304, each partition being associated with a given system and thus integrates the transmission characteristics of the signal from said system.

Thereafter, when the user wishes to use voice recognition, the communication terminal recognizes the system used, such recognition being used already to reduce echoes and background noise.

Finally, it compares the parameters extracted by the means 302 from the signal 320, 322 or 324 to the sets of parameters that are stored in the partition corresponding to the system used. This reduces by a factor of 3 the number of comparisons needed.

This embodiment lends itself to numerous variants. One variant employs comparison of the sequence spoken by the user with the partition used at that particular time.

If the comparisons do not satisfy the required recognition rate, then the comparisons are continued in other partitions until successful or until no satisfactory matches are found in memory.

A second embodiment of the invention is represented diagrammatically in FIG. 4 which shows a communication terminal 400 containing in particular voice recognition means 402, a database 404, management means 412 of the communication terminal and a sound acquisition system 405 including in particular a microphone 406.

The communication terminal may also operate with two other sound acquisition systems including two other microphones: a system 407 including in particular a microphone 408, said system 407 being a hands-free kit, for example, and a system 409 including in particular a microphone 410, said system 409 being a car hands-free kit, for example.

In this embodiment, the signal transmission characteristics of the various sound signal acquisition systems 405, 407 and 409 associated with the communication terminal 400 are known before said systems are used.

In fact, the various sound signal acquisition systems 405, 407 and 409 associated with the communication terminal 400 behave like filters.

There are then integrated into the voice recognition means 402:
filter means 414 associated with the sound signal acquisition system 405 internal to the communication terminal 400,
filter means 416 associated with the sound signal acquisition system 407 external to the communication terminal 400,
filter means 418 associated with the sound signal acquisition system 409 external to the communication terminal 400.

In more detail, FIG. 5 is an example of adaptation of spectral characteristics by inverse filtering, which is a particular form of filtering that can be used in this embodiment.

This FIG. 5 represents three curves of the attenuation, for example in dB, plotted on the ordinate axis 502 as a function of the frequency plotted on the abscissa axis 504.

The curve 506 represents the frequency response of a sound signal acquisition system 405, 407 or 409. The curve 508 represents the frequency response of one of the filter means 414, 416 or 418 associated with the system 405, 407 or 409, respectively.

Thus there is obtained at the output of the inverse filtering means a flat response 510 that does not depend on the frequency in the required pass-band and does not depend on the sound acquisition system used.

If these inverse filters are applied to each acquisition system, comparable signals are obtained at the output of the various inverse filter means.

In this embodiment, it therefore suffices to perform the learning process using only one acquisition system or to make the multispeaker recordings allowing only for the characteristics of one acquisition system, in particular the internal system 405.

In fact, the corresponding set of parameters stored in the database 404 may be homogeneously compared by voice recognition means 420 to one of the input signals 422, 424 or 426 of said voice recognition means 420, independently of the fact that said signals 422, 424 or 426 were processed in the filter means 414, the filter means 416 or the filter means 418 on the basis of the signals 428, 430 or 432, respectively.

This embodiment lends itself to numerous variants, for example using filter means 414 external to the internal system 405.

A third embodiment of the invention is represented in FIG. 6. In this embodiment, a communication terminal 600 includes in particular voice recognition means 602, a database 614, management means 616 of the communication terminal and sound signal acquisition means 607, said means 607 including in particular a microphone 608.

Another sound signal acquisition system 609 may be connected to the communication terminal 600 if this is what the user wants. That system 609 may be a hands-free kit or a car hands-free kit in particular.

The voice recognition means 602 comprise:
signal processing means 604 for the sound signal acquisition system 607,
adaptive filter means 612,
algorithmic means 606 for executing a voice recognition algorithm using the database 614.

The adaptive filter means 612 detect processing characteristics of the signal from the system 609 by comparing, when the user is not speaking, a signal 618 coming from the system 609 with a signal 622 in order to identify the filter means 612 delivering a signal 620 analogous to the signal 622.

In other words, the ambient environment is listened to twice over through the system 607 and the system 609, alternately or simultaneously depending on the implementation.

A variant of this embodiment effects this two-fold listening, not in the learning step, but systematically during operation, in particular at given time intervals or on each call made or received.

Once the parameters 612 have been calculated, they must be retained for processing the signal 618 in the recognition phase.

The adapted signal 618 becomes a signal 620 which can then be processed by the algorithmic means 606 to extract therefrom the parameters needed by said algorithm and then to compare those parameters with the sets of parameters stored in the database 614.

In FIG. 6 there are also represented means 604 that process a signal 624 coming from the sound signal acquisition system 607 to adapt it additionally to predetermined levels and transform it into a signal 622.

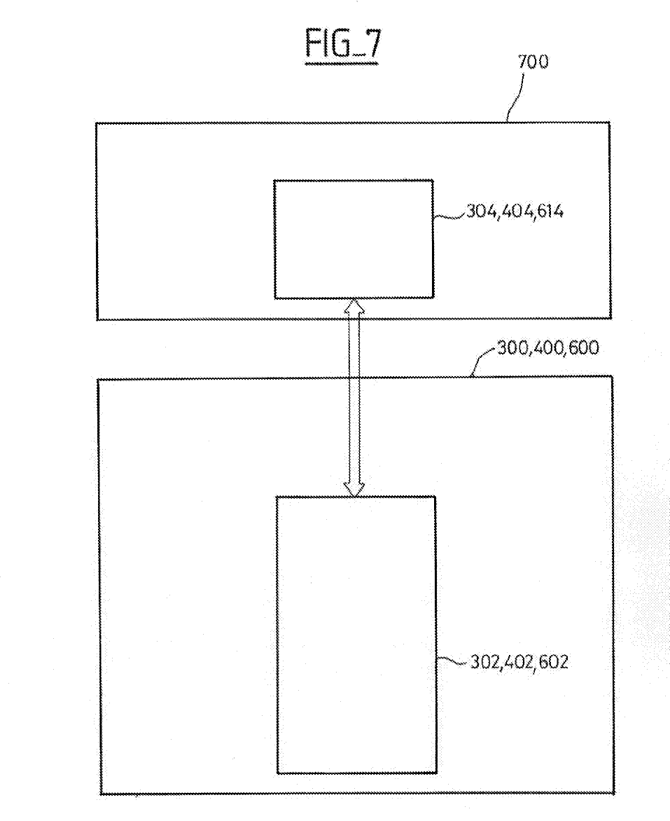

In FIG. 7, the mobile communication terminal 300, 400, 600 sends and receives calls in a radiocommunication network. The database 304, 404, 614 is external to the mobile communication terminal, in a server 700 that is also situated in the radiocommunication network.

1. Method of processing voice signals (320, 322, 324, 428, 430, 432, 618, 624) for a communication terminal (300, 400, 600) using voice recognition means (302, 402, 602) comparing those voice signals to data stored in a database (304, 404, 614) in order to identify the data corresponding to those signals, that identified data being transmitted to management means (312, 412, 616) for triggering an action, characterized in that, the voice signals being liable to be supplied different sound acquisition systems (305, 307, 309, 405, 407, 409, 607, 609), separate voice recognition means are used for each acquisition system.

2. Method according to claim 1 characterized in that the database (304) comprises independent sub-bases (314, 316, 318), each sub-base (314, 316, 318) being associated with one sound acquisition system (305, 307, 309) so that the voice recognition means give priority to using the sub-base (314, 316, 318) associated with the sound acquisition system (305, 307, 309) used to effect the comparison.

3. Method according to claim 2 characterized in that the comparison between a signal (320, 322, 324) and the stored data is done successively for each of the sub-bases (314, 316, 318) until a required recognition rate is achieved by that comparison.

4. Method according to claim 2 characterized in that a voice recognition learning procedure is done with different voice recognition systems (305, 307, 309) to generate the sub-bases (314, 316, 318) specific to each voice recognition system.

5. Method according to claim 1 characterized in that the voice recognition means of the communication terminal incorporate at least two sound signal filters (414, 416, 418), each of the filters being specific to one sound acquisition system (405, 407, 409) of the communication terminal.

6. Method according to claim 5 characterized in that the filters (414, 416, 418) have predetermined filter characteristics.

7. Method according to claim 5 characterized in that the signals (422, 424, 426) delivered by the filters (414, 416, 418) are processed identically by the voice recognition means vis à vis the database (404).

8. Method according to claim 1 characterized in that the voice recognition means contain fixed filter means (604) associated with a first voice recognition system (607) and dynamic filter means (612) associated with a second filter system (609), these dynamic filter means (612) detecting the characteristics of the fixed filtering to deliver a signal analogous to the signal delivered by the fixed filtering.

9. Communication terminal (300, 400, 600) processing voice signals (320, 322, 324, 428, 430, 432, 618, 624) using voice recognition means comparing those voice signals to data stored in a database (304, 404, 614) in order to identify the data corresponding to those signals, that identified data being transmitted to management means (312, 412, 616) for triggering an action, characterized in that, the voice signals being liable to be supplied different sound acquisition systems (305, 307, 309, 405, 407, 409, 607, 609), it comprises separate voice recognition means for each acquisition system.

10. Communication terminal according to claim 9, characterized in that the database (304, 404, 614) is situated externally of the communication terminal in a server (700).

11. Communication terminal according to claim 9 characterized in that it includes, in the database (304, 404, 614), independent sub-bases (314, 316, 318), each sub-base (314, 316, 318) being associated with one sound acquisition system (305, 307, 309) so that the voice recognition means give priority to using the sub-base associated with the sound acquisition system used by the user to do the comparison.

12. Communication terminal according to claim 11 characterized in that it comprises means for doing the comparison between a signal (320, 322, 324) and the stored data successively for each of the sub-bases until a required recognition rate is achieved by that comparison.

13. Communication terminal according to claim 11 characterized in that it comprises means for doing a voice recognition learning procedure with different voice recognition systems (305, 307, 309) to generate the sub-bases (314, 316, 318) specific to each voice recognition system.

14. Communication terminal according to claim 9 characterized in that it comprises in the voice recognition means of the communication terminal at least two sound signal filters (414, 416, 418), each of the filters being specific to one sound acquisition system (405, 407, 409) of the communication terminal.

15. Communication terminal according to claim 14 characterized in that the filters (414, 416, 418) have predetermined fixed filter characteristics.

16. Communication terminal according to claim 14 characterized in that it comprises means whereby the filtered signals (422, 424, 426) are processed identically by the voice recognition means vis à vis the database (404).

17. Communication terminal according to claim 9 characterized in that the voice recognition means contain fixed filter means (604) associated with a first voice recognition system (607) and dynamic filter means (612) associated with a second filter system (609), these dynamic filter means (612) detecting the characteristics of the fixed filtering to deliver a signal analogous to the signal delivered by the fixed filtering.

18. Communication terminal according to claim 9 characterized in that one of the sound acquisition systems comprises a microphone.

19. Communication terminal according to claim 9 characterized in that one of the sound acquisition systems is a pedestrian hands-free kit, a hands-free kit for a vehicle or a recognition system integrated into the communication terminal.
